(19) United States
(12) Patent Application Publication
(10) Pub. No.: US 2007/0249294 A1
(43) Pub. Date: Oct. 25, 2007

(54) TRANSMIT-RECEIVE SWITCH FOR ULTRAWIDEBAND AND METHOD FOR ISOLATING TRANSMITTING AND RECEIVING SIGNAL THEREOF

(76) Inventors: Chang-Ching Wu, Hsinchu City (TW); Albert Kuo Huei Yen, San Jose, CA (US); Jen-Chung Chang, Jhongli City (TW); Yu-Yee Liow, Jhubei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,666

(22) Filed: Apr. 20, 2006

(51) Int. Cl. H04B 1/44

(52) U.S. Cl. 455/78

(57) ABSTRACT

A transmit-receive switch for ultrawideband and a method for isolating transmitting and receiving signal thereof are provided. The transmit-receive switch includes a first switch, a second switch, and an inductor. The first switch has a first end coupled to a signal transmitting end, a second end coupled to a signal transmit-receive end, and a control end receiving a first control signal to decide whether or not to turn on the first switch according to the first controlling signal. The second switch has a first end coupled to a signal receiving end, a second end coupled to the signal transmit-receive end, and a control end receiving a second control signal to decide whether or not to turn on the second switch according to the second controlling signal. The inductor has an end coupled to the signal transmit-receive end, and another end coupled to a first potential.

### BACKGROUND OF THE INVENTION

1. Field of Invention

The present invention relates to a transmit-receive switch and a method for isolating transmitting and receiving signal thereof. More particularly, the present invention relates to a transmit-receive switch and a method for isolating transmitting and receiving signal applicable to the ultrawideband wireless communication technique. The transmit-receive switch and the method are capable of providing an electrostatic discharge protection function, reducing the chip volume, and isolating transmitting and receiving signal effectively, and the voltage level of the control signal is not high.

2. Description of Related Art

Different from conventional wireless communication technique, ultrawideband (UWB) wireless communication technique employs a manner of quickly sending out pulses other than successive sine waves to transmit data, and also employs a manner of time modulation. The pulse signal of UWB occupies a short time period in the time domain and thus has a wide bandwidth in frequency domain.

According to the Shannon maximal channel capacity formula: Transmission rate=Frequency band of use×log₂ (1+S/N), where S is the power of the signal and N is the power of the noise. The transmission rate linearly increases with the increasing of the frequency band of use. Therefore, in theory, the wider the frequency band of use is, the larger the transmitting capacity is. In this manner, it is apparent why the UWB can easily achieve a transmission rate of more than 100 Mbps or 480 Mbps, etc.

Therefore, owing to the characteristics of high speed transmission and low power consumption, manufacturers have tried to use this technique in multimedia and various electronic products of short-distance wireless transmission with high-speed. However, all the electronic products adopting the UWB wireless communication technique must be fitted with a transmit-receive switch to function normally. The following are two examples of the transmit-receive switch.

FIG. 1 is a conventional transmit-receive switch for ultrawideband. Referring to FIG. 1, the transmit-receive switch as shown in FIG. 1 is designed to be disposed in the wireless communication chip. As seen from FIG. 1, the conventional transmit-receive switch for ultrawideband requires at least two inductors, i.e. inductors 101, 102. However, since the inductors 101, 102 are plane-spiral inductor that occupies a large area, the more the plane-spiral inductors are in the wireless communication chip, the larger the wireless communication chip is, which negatively affects the microminiaturization of the electronic products. The bandwidth of the transmit-receive switch for ultrawideband is also limited by the filter having an inductor 101 and capacitors 103 and 104 in the receiving path of the conventional transmit-receive switch for ultrawideband.

FIG. 2 is another conventional transmit-receive switch for ultrawideband. FIG. 2 shows that an electrostatic discharge (ESD) protection device is not included in the transmitting and receiving paths of the conventional transmit-receive switch for ultrawideband. However, for the conventional transmit-receive switch for ultrawideband, the signal transmitted is likely to be interfered by electrostatic and also the components of the conventional transmit-receive switch for ultrawideband are easy to be damaged by electrostatic. Even the components of the electronic devices connected to the conventional transmit-receive switch for ultrawideband may damaged. Thus, the instability of the electronic device adopting the conventional transmit-receive switch for ultrawideband is increased.

Furthermore, according to the requirement of the conventional transmit-receive switch for ultrawideband, the voltage level of the control voltage V_{CTRL} and /V_{CTRL} must be higher than the direct current bias supplied to the conventional transmit-receive switch for ultrawideband. So it is inconvenient for the user to use the conventional transmit-receive switch for ultrawideband.

### SUMMARY OF THE INVENTION

Accordingly, the present invention provides a transmit-receive switch for ultrawideband, which is capable of providing an electrostatic discharge protection function and isolating transmitting and receiving signal effectively. The area occupied by the chip is small, the bandwidth of the transmit-receive switch is broad bandwidth. Furthermore, the voltage level of the control signal of the present invention is not required to be high.

The present invention provides a method for isolating transmitting and receiving signal, so as to make the transmit-receive switch for ultrawideband have a high capability of transmitting and receiving signals.

The present invention provides a transmit-receive switch for ultrawideband. The transmit-receive switch for ultrawideband comprises a first switch, a second switch, and an inductor. The first switch has a first end, a second end, and a control end, where the first end is coupled to a signal transmitting end, the second end is coupled to a signal transmit-receive end, and the control end receives a first control signal so as to decide whether or not to turn on the first switch according to the first control signal. The second switch has a first end, a second end, and a control end, where the first end is coupled to a signal receiving end, the second end is coupled to the signal transmit-receive end, and the control end receives a second control signal, so as to decide whether or not to turn on the second switch according to the second control signal. One end of the inductor is coupled to the signal transmit-receive end, and another end of the inductor is coupled to a first potential.

The present invention provides a transmit-receive switch for ultrawideband. The transmit-receive switch for ultrawideband comprises a first transistor, a second transistor, a control device, and an inductor. The first transistor has a first end, a second end, and a control end, where the first end is coupled to a signal transmitting end and the second end is coupled to a signal transmit-receive end. The second transistor has a first end, a second end, and a control end, where the first end is coupled to a signal receiving end and the second end is coupled to the signal transmit-receive end.

The control device is coupled between the control end of the first transistor and the control end of the second transistor. The control device receives a control signal, and the first transistor or the second transistor is turned on according to the control signal. When the first transistor is turned on to allow the signal transmitting end transmit an output signal, the control end of the second transistor is coupled to the ground voltage by the control device, such that the output signal that passes through the second transistor to the signal receiving end is conducted to the ground voltage by the second transistor through the control end of the second transistor by the parasitic capacitance of the second transistor. When the second transistor is turned on to allow the signal receiving end receive an input signal, the control end of the first transistor is coupled to the ground voltage, such that the input signal that passes through the first transistor to the signal transmitting end is conducted to the ground voltage by the first transistor through the control end of the first transistor by the parasitic capacitance of the first transistor. One end of the inductor is coupled to the signal transmit-receive end, and another end of the inductor is coupled to the ground voltage.

The present invention provides a transmit-receive switch for ultrawideband. The transmit-receive switch for ultrawideband comprises a first MOS transistor, a second MOS transistor, an inverting device, and an inductor. One source/drain end of the first MOS transistor is coupled to a signal transmitting end, and the other source/drain end of the first MOS transistor is coupled to a signal transmit-receive end. One source/drain end of the second MOS transistor is coupled to a signal receiving end, and the other source/drain end of the second MOS transistor is coupled to the signal transmit-receive end. The input end of the inverting device is coupled to the gate end of the first MOS transistor, and the output end of the inverting device is coupled to the gate end of the second MOS transistor. The input end of the inverting device receives a control signal, and the output end of the inverting device outputs an inverted signal of the control signal. One end of the inductor is coupled to the signal transmit-receive end, and the other end of the inductor is coupled to a first potential.

The present invention provides a method for isolating transmitting and receiving signal, applicable to a receive-transmit signal switching circuit having a first MOS transistor and a second MOS transistor. One source/drain end of the first MOS transistor is coupled to a signal transmitting end, and the other source/drain end of the first MOS transistor is coupled to a signal transmit-receive end. One source/drain end of the second MOS transistor is coupled to a signal receiving end, and the other source/drain end of the second MOS transistor is coupled to the signal transmit-receive end. The method comprises when the first MOS transistor is turned on to allow the signal transmitting end transmit an output signal through the signal transmit-receive end, turning off the second MOS transistor and coupling the gate end of the second MOS transistor to the ground voltage; when the second MOS transistor is turned on to allow the signal receiving end receive an input signal through the signal transmit-receive end, turning off the first MOS transistor and coupling the gate end of the first MOS transistor to the ground voltage, wherein the first MOS transistor and the second MOS transistor are not turned on simultaneously.

According to an embodiment of the present invention, the control device comprises an inverter, a first bypass device, and a second bypass device. The input end of the inverter receives the control signal, and the output end of the inverter outputs the inverted signal of the control signal. The first bypass device is coupled between the input end of the inverter and the control end of the first transistor so as to transmit the control signal to the control end of the first transistor. The first bypass device also receives the inverted signal of the control signal and decides whether or not to couple the control end of the first transistor to the ground voltage according to the inverted signal of the control signal. The second bypass device is coupled between the output end of the inverter and the control end of the second transistor so as to transmit the inverted signal of the control signal to the control end of the second transistor. The second bypass device also receives the control signal, and decides whether or not to couple the control end of the second transistor to the ground voltage according to the control signal.

According to an embodiment of the present invention, the first bypass device comprises a second resistor, a first switch, and a first capacitor. The second resistor is coupled between the input end of the inverter and the control end of the first transistor. The first switch has a first end, a second end, and a control end, where the first end and the second end are respectively coupled to the two ends of the second resistor, and the control end receives the inverted signal of the control signal. When the second transistor is turned on, the first switch is turned on. One end of the first capacitor is coupled to the input end of the inverter, and the other end of the first capacitor is coupled to the ground voltage.

According to an embodiment of the present invention, the second bypass device comprises a third resistor, a second switch, and a second capacitor. The third resistor is coupled between the output end of the inverter and the control end of the second transistor. The second switch has a first end, a second end, and a control end, where the first end and the second end are respectively coupled to the two ends of the third resistor, and the control end receives the control signal. When the first transistor is turned on, the second switch is turned on. One end of the second capacitor is coupled to the output end of the inverter, and the other end of the second capacitor is coupled to the ground voltage.

According to an embodiment of the present invention, the first switch comprises an NMOS transistor. The two source/drain ends of the NMOS transistor are respectively the first end and the second end of the first switch and the gate end of the NMOS transistor is the control end of the first switch.

According to an embodiment of the present invention, the second switch comprises an NMOS transistor. The two source/drain ends of the NMOS transistor are respectively the first end and the second end of the second switch and the gate end of the NMOS transistor is the control end of the second switch.

According to an embodiment of the present invention, the first switch comprises a PMOS transistor. The two source/drain ends of the PMOS transistor are respectively the first end and the second end of the first switch and the gate end of the PMOS transistor is the control end of the first switch.

According to an embodiment of the present invention, the second switch comprises a PMOS transistor. The two source/drain ends of the PMOS transistor are respectively the first end and the second end of the second switch and the gate end of the PMOS transistor is the control end of the second switch.

According to an embodiment of the present invention, the first potential is a ground voltage.

According to an embodiment of the present invention, the first transistor and the second transistor each comprise an NMOS transistor or a PMOS transistor.

According to an embodiment of the present invention, each of the first MOS transistor and the second transistor MOS comprises an NMOS transistor or a PMOS transistor.

According to an embodiment of the present invention, the inverting device comprises an inverter with the input end for receiving a control signal and the output end for outputting the inverted signal of the control signal.

According to an embodiment of the present invention, the inverting device further comprises a first resistor, a second resistor, and a third resistor. One end of the first resistor is coupled to the control signal, and the other end of the first resistor is coupled to the input end of the inverter. One end of the second resistor is coupled to the input end of the inverter, and the other end of the second resistor is coupled to the gate end of the first MOS transistor. One end of the third resistor is coupled to the output end of the inverter, and the other end of the third resistor is coupled to the gate end of the second MOS transistor.

According to an embodiment of the present invention, the signal transmit-receive end is coupled to an antenna.

According to the technique adopted in the present invention, when the first transistor is turned on to allow the signal transmitting end transmit an output signal, the control end of the second transistor is coupled to the ground voltage, such that the output signal that passes through the second transistor to the signal receiving end is conducted to the ground voltage by the second transistor through the control end of the second transistor by the parasitic capacitance of the second transistor. When the second transistor is turned on to allows the signal receiving end receive an input signal, the control end of the first transistor is coupled to the ground voltage, such that the input signal that passes through the first transistor to the signal transmitting end is conducted to the ground voltage by the first transistor through the control end of the first transistor by the parasitic capacitance of the first transistor. In this manner, the present invention can efficiently isolate the output signal and the input signal, thus avoiding the interference between the output signal and the input signal. In the present invention, one end of the inductor is coupled to the signal transmit-receive end (the signal transmit-receive end can be coupled to the antenna), and the other end of the inductor is coupled to the ground voltage. Therefore, the present invention provides the function of ESD protection.

Furthermore, compared with the conventional transmit-receive switch for ultrawideband as shown in FIG. 1, the present invention employs one inductor (two inductors are included in the conventional transmit-receive switch for ultrawideband as shown in FIG. 1), so the volume of the chip using the present invention is smaller than that of the chip using the conventional transmit-receive switch for ultrawideband as shown in FIG. 1, and the bandwidth of the present invention is wider. Compared with the conventional transmit-receive switch for ultrawideband as shown in FIG. 2, the voltage level of the control signal of the present invention is not required to be high.

In order to the make aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

FIG. 1 shows a conventional transmit-receive switch for ultrawideband.

FIG. 2 shows another conventional transmit-receive switch for ultrawideband.

FIG. 3 is an installation diagram of a transmit-receive switch for ultrawideband according to an embodiment of the present invention.

FIG. 4 and FIG. 5 are installation diagrams of a transmit-receive switch for ultrawideband according to another embodiment of the present invention.

FIG. 6 is a method for isolating the transmitting and receiving signals according to an embodiment of the present invention.

FIG. 7 is a comparison table of the characteristics of the conventional transmit-receive switch for ultrawideband and that of the transmit-receive switch for ultrawideband of the present invention.

### DESCRIPTION OF EMBODIMENTS

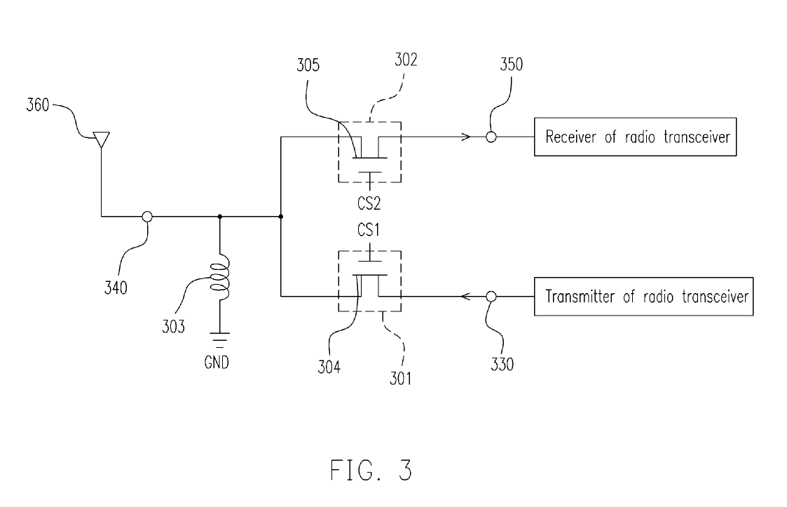

FIG. 3 is an installation diagram of a transmit-receive switch for ultrawideband according to an embodiment of the present invention. Referring to FIG. 3, the transmit-receive switch for ultrawideband shown in FIG. 3 comprises a first switch 301, a second switch 302, and an inductor 303. Each of the first switch 301 and the second switch 302 has a first end, a second end, and a control end. In this embodiment, the first switch 301 and the second switch 302 are implemented by an NMOS transistor 304 and an NMOS transistor 305 respectively.

The source end and the drain end of the NMOS transistor 304 are the first end and the second end of the first switch 301 respectively, and the gate end is the control end of the first switch 301. The source end and the drain end of the NMOS transistor 305 are the first end and the second end of the second switch 302 respectively, and the gate end is the control end of the second switch 302.

The source end of the NMOS transistor 304 is coupled to the signal transmitting end 330, the drain end of the NMOS transistor 304 is coupled to the signal transmit-receive end 340, and the gate end of the NMOS transistor 304 receives a first control signal CS1 to decide whether or not to turn on the NMOS transistor 304 according to the first control signal CS1.

The source end of the NMOS transistor 305 is coupled to the signal receiving end 350, the drain end of the NMOS transistor 305 is coupled to the signal transmit-receive end 340, and the gate end of the NMOS transistor 305 receives a second control signal CS2 to decide whether or not to turn on the NMOS transistor 305 according to the second control signal CS2.

One end of the inductor 303 is coupled to the signal transmit-receive end 340, and the other end is coupled to the first potential (a ground voltage GND in the embodiment). The inductor 303 is used to provide the transmit-receive switch for ultrawideband with the ESD protecting function. In addition, the inductor 303 generates resonance with the parasitic capacitances of the NMOS transistors 304 and 305 through appropriately adjusting the value of the inductor 303, such that the impedances of the NMOS transistors 304 and 305 are reduced, and thereby the insertion loss is further reduced. The so-called insertion loss is signal attenuation loss generated when the device is inserted into a transmitting system.

The second control signal is an inverted signal of the first control signal. However, in another embodiment, the second control signal may be any control signal with a duty cycle being different from that of the first control signal.

The signal transmitting end 330 is coupled to a device used for providing the transmitting signal, e.g. a transmitter of a radio transceiver. The signal receiving end 350 is coupled to a device used for receiving the transmitting signal, e.g. a receiver of a radio transceiver. The signal transmit-receive end 340 is coupled to a radio wave transmitting device, e.g. an antenna 360, or a light wave transmitting device, e.g. an optical fiber (not shown). The signal transmitting end, signal receiving end, and signal transmit-receive end described in the following embodiments are the same as the signal transmitting end 330, signal receiving end 350 and signal transmit-receive end 340 in FIG. 3, and thus will not be described herein anymore.

Further, in the embodiment, the first switch 301 and the second switch 302 are not limited to be implemented by the NMOS transistor, and the PMOS transistor, or other devices with switching actions and parasitic capacitances also can be used.

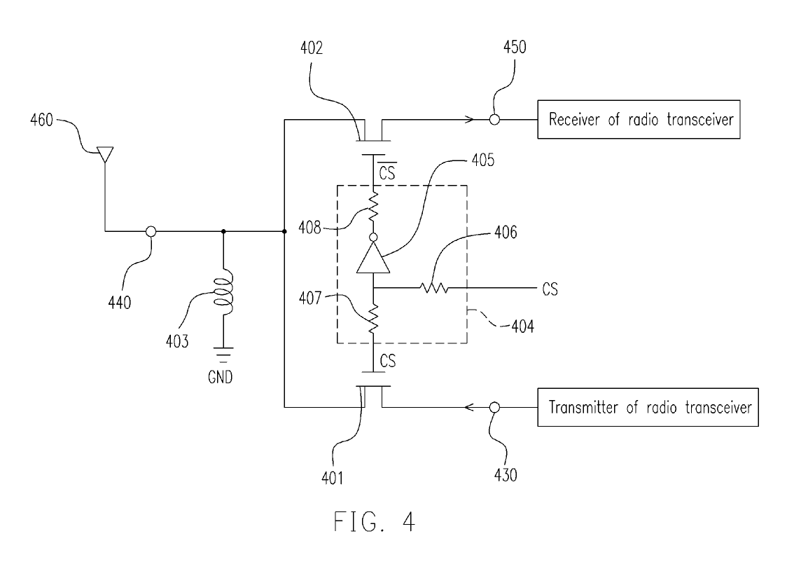

FIG. 4 is an installation diagram of a transmit-receive switch for ultrawideband according to another embodiment of the present invention. Referring to FIG. 4, the transmit-receive switch for ultrawideband shown in FIG. 4 comprises a first MOS transistor 401, a second MOS transistor 402, an inductor 403 and an inverting device 404. In this embodiment, the first MOS transistor 401 and the second MOS transistor 402 are both implemented by the NMOS transistor.

The source end of the first MOS transistor 401 is coupled to a signal transmitting end 430, and the drain end is coupled to a signal transmit-receive end 440. The source end of the second MOS transistor 402 is coupled to a signal receiving end 450, and the drain end is coupled to the signal transmit-receive end 440. The signal transmit-receive end 440 is coupled to an antenna 460.

One end of the inductor 403 is coupled to the signal transmit-receive end 440, and the other end is coupled to a first potential (a ground voltage GND in the embodiment). The input end of the inverting device 404 is coupled to the gate end of the first MOS transistor 401, and the output end is coupled to the gate end of the second MOS transistor 402. The input end of the inverting device 404 receives a control signal CS, and the output end outputs the inverted signal /CS of the control signal CS.

The inverting device 404 comprises an inverter 405, a first resistor 406, a second resistor 407 and a third resistor 408. One end of the first resistor 406 is coupled to the control signal CS, and the other end is coupled to the input end of the inverter 405. One end of the second resistor 407 is coupled to the input end of the inverter 405, and the other end is coupled to the gate end of the first MOS transistor 401. One end of the third resistor 408 is coupled to the output end of the inverter 405, and the other end is coupled to the gate end of the second MOS transistor 402.

The operations of the transmit-receive switch for ultrawideband in the embodiment are described as follows. When the control signal CS is at a high potential (i.e. logic 1), the first MOS transistor 401 is turned on, and the second MOS transistor 402 is turned off, thus the signal transmitting end 430 starts to transmit the output data via the signal transmit-receive end 440. When the control signal CS is at a low potential (i.e. logic 0), the second MOS transistor 402 is turned on, and the first MOS transistor 401 is turned off, thus the signal receiving end 450 starts to receive the input data via the signal transmit-receive end 440.

The function of the inductor 403 is similar to that of the inductor 303 shown in FIG. 3, so the inductor 403 is also used to provide the transmit-receive switch for ultrawideband with the ESD protecting function. It is necessary to appropriately adjust the value of the inductor 403, such that the inductor 403 generates resonance with the parasitic capacitances of the first MOS transistor 401 and the second MOS transistor 402, thus the insertion loss is reduced. Further, in the embodiment, the second resistor 407 and the third resistor 408 not only provide transmitting paths for the control signal CS and the inverted signal of the control signal CS respectively, but also enhance the linearity of the first MOS transistor 401 and the second MOS transistor 402 respectively.

This embodiment is not limited to be implemented with NMOS transistors, and PMOS transistors or other transistors with parasitic capacitance also can be used depending on practical demands.

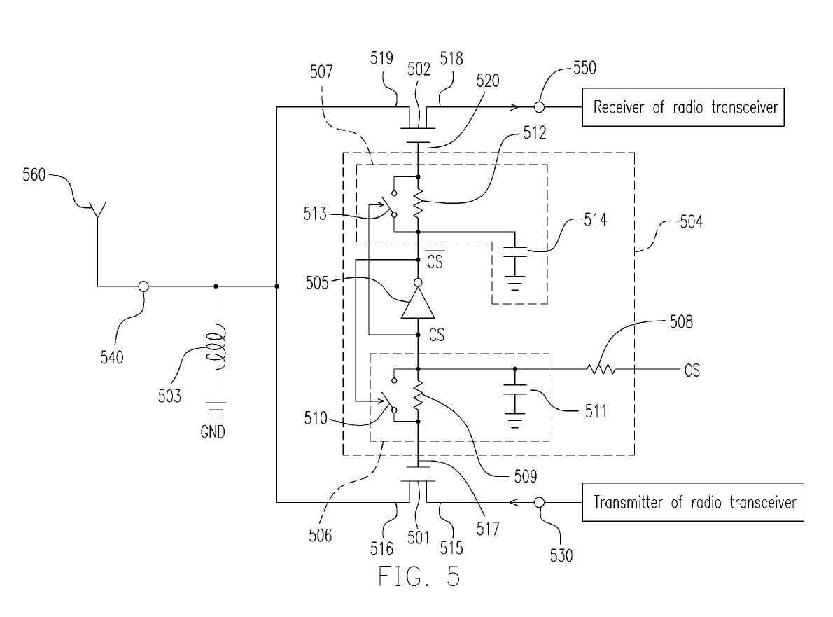

FIG. 5 is an installation diagram of a transmit-receive switch for ultrawideband according to another embodiment of the present invention. Referring to FIG. 5, the transmit-receive switch for ultrawideband comprises a first transistor 501, a second transistor 502, an inductor 503 and a control device 504. In the embodiment, the first transistor 501 and the second transistor 502 are both implemented by the NMOS transistor. The source ends of the NMOS transistors are the first end 515 of the first transistor 501 and the first end 518 of the second transistor 502. The drain ends of the NMOS transistors are the second end 516 of the first transistor 501 and the second end 519 of the second transistor 502. The gate ends of the NMOS transistors are the control end 517 of the first transistor 501 and the control end 520 of the second transistor 502.

The source end of the first transistor 501 is coupled to a signal transmitting end 530, and the drain end is coupled to a signal transmit-receive end 540. The source end of the second transistor 502 is coupled to a signal receiving end 550, and the drain end is coupled to the signal transmit-receive end 540. The signal transmit-receive end 540 is coupled to an antenna 560. One end of the inductor 503 is coupled to the signal transmit-receive end 540, and the other end is coupled to a ground voltage GND.

The control device 504 is coupled between the gate end of the first transistor 501 and the gate end of the second transistor 502. The control device 504 receives a control signal CS, and turns on one of the first transistor 501 and the second transistor 502 according to the control signal CS. When the first transistor 501 is turned on to allow the signal transmitting end 530 to transmit an output signal, the gate end of the second transistor 502 is coupled to the ground voltage GND by the control device 504, such that the output signal that passes through the second transistor 502 to the signal receiving end 550 is conducted to the ground voltage GND by the second transistor 502 through the gate end of the second transistor 502 by utilizing the parasitic capacitance of the second transistor 502. When the second transistor 502 is turned on to allow the signal receiving end 550 to receive an input signal, the gate end of the first transistor 501 is coupled to the ground voltage GND by the control device 504, such that the input signal that passes through the first transistor 501 to the signal transmitting end 530 is conducted to the ground voltage GND by the first transistor 501 through the gate end of the first transistor 501 by utilizing the parasitic capacitance of the first transistor 501.

The control device 504 comprises an inverter 505, a first bypass device 506, a second bypass device 507 and a first resistor 508. The input end of the inverter 505 receives the control signal CS, and the output end outputs the inverted signal /CS of the control signal CS. The first bypass device 506 is coupled between the input end of the inverter 505 and the gate end of the first transistor 501 to transmit the control signal CS to the gate end of the first transistor 501. The first bypass device 506 also receives the inverted signal /CS of the control signal CS and decides whether the gate end of the first transistor 501 is coupled to the ground voltage GND according to the inverted signal /CS of the control signal CS.

The second bypass device 507 is coupled between the output end of the inverter 505 and the gate end of the second transistor 502 to transmit the inverted signal /CS of the control signal CS to the gate end of the second transistor 502. The second bypass device 507 also receives the control signal CS and decides whether the gate end of the second transistor 502 is coupled to the ground voltage GND according to the control signal CS.

One end of the first resistor 508 is coupled to the control signal CS, and the other end is coupled to the input end of the inverter 505.

The first bypass device 506 comprises a second resistor 509, a first switch 510 and a first capacitor 511. The second resistor 509 is coupled between the input end of the inverter 505 and the gate end of the first transistor 501. The first switch 510 has a first end, a second end, and a control end. The first and second ends of the first switch 510 are coupled to the two ends of the second resistor 509 respectively. The control end of the first switch 510 receives the inverted signal /CS of the control signal CS. When the second transistor 502 is turned on, the first switch 510 is turned on. One end of the first capacitor 511 is coupled to the input end of the inverter 505, and the other end is coupled to the ground voltage GND.

The second bypass device 507 comprises a third resistor 512, a second switch 513 and a second capacitor 514. The third resistor 512 is coupled between the output end of the inverter 505 and the gate end of the second transistor 502. The second switch 513 has a first end, a second end, and a control end. The first and second ends of the second switch 513 are coupled to the two ends of the third resistor 512 respectively, and the control end of the second switch 513 receives the control signal CS. When the first transistor 501 is turned on, the second switch 513 is turned on. One end of the second capacitor 514 (In this embodiment, the capacitor 514 may be omitted.) is coupled to the output end of the inverter 505, and the other end is coupled to the ground voltage GND.

The function of the inductor 503 in this embodiment is similar to the function of the inductor 403 shown in FIG. 4 and the functions of the second resistor 509 and the third resistor 512 are similar to the functions of the second resistor 407 and the third resistor 408 shown in FIG. 4 respectively, and thus will not be described herein any more. However, the first transistor 501 and the second transistor 502 of this embodiment are not limited to be NMOS transistors, and PMOS transistors or other transistors with parasitic capacitance also can be used depending on practical demands.

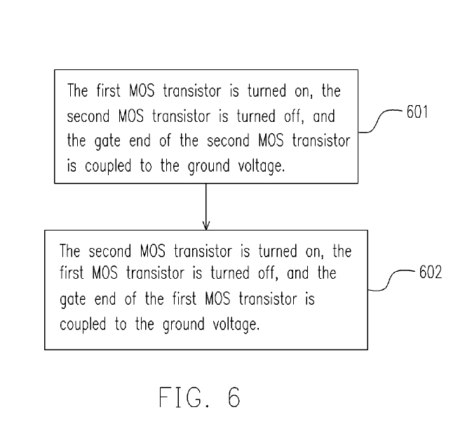

FIG. 6 is a method for isolating the transmitting and receiving signal according to an embodiment of the present invention. The method for isolating the signal transmitting and the signal receiving of this embodiment is suitable for a receive-transmit signal switching circuit including a first MOS transistor and a second MOS transistor. As for the embodiment of FIG. 5, the first MOS transistor is the first transistor 501 implemented by an NMOS in FIG. 5, and the second MOS transistor is the second transistor 502 implemented by an NMOS in FIG. 5. Referring to FIG. 6 and FIG. 5, depending on the needs of description, the method comprises the following steps.

When the first MOS transistor (i.e. first transistor 501 implemented by an NMOS) is turned on to allow the signal transmitting end 530 to transmit an output signal through the signal transmit-receive end 540, the second MOS transistor (i.e. second transistor 502 implemented by an NMOS) is turned off, and the gate end of the second MOS transistor is coupled to the ground voltage GND (Step 601 shown in FIG. 6). Thus, the output signal that passes through the second MOS transistor to the signal receiving end 550 is conducted to the ground voltage GND by the second MOS transistor through the gate end of the second MOS transistor by utilizing the parasitic capacitance of the second MOS transistor.

When the second MOS transistor is turned on to allow the signal receiving end 550 to receive an input signal through the signal transmit-receive end 540, the first MOS transistor is turned off, and the gate end of the first MOS transistor is coupled to the ground voltage (Step 602 shown in FIG. 6). The first and second MOS transistors are not turned on simultaneously. Thus, the input signal that passes through the first MOS transistor to the signal transmitting end 530 is conducted to the ground voltage GND by the first MOS transistor through the gate end of the first MOS transistor by utilizing the parasitic capacitance of the first MOS transistor.

The MOS transistor used in this method is not limited to be an NMOS transistor, and a PMOS transistor or other device having a switching action and parasitic capacitance also can be used.

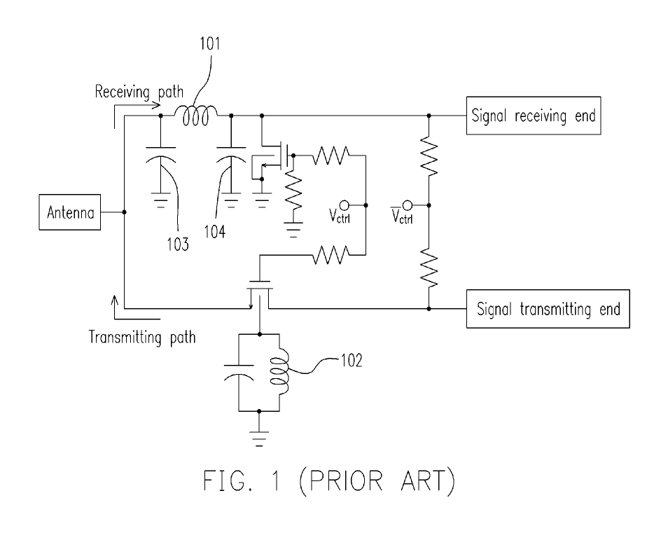

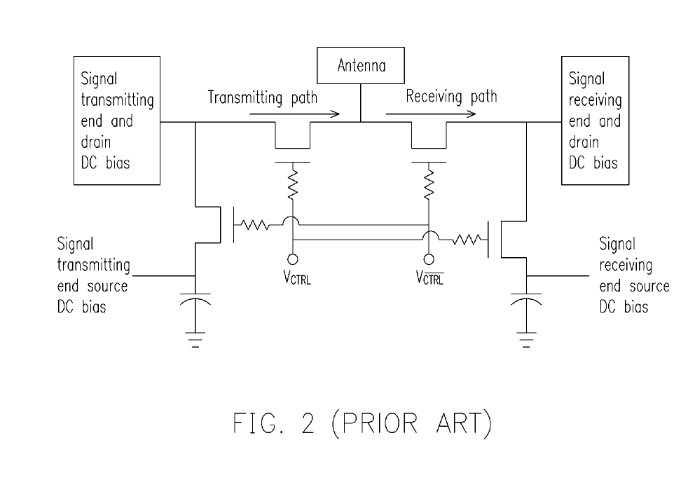

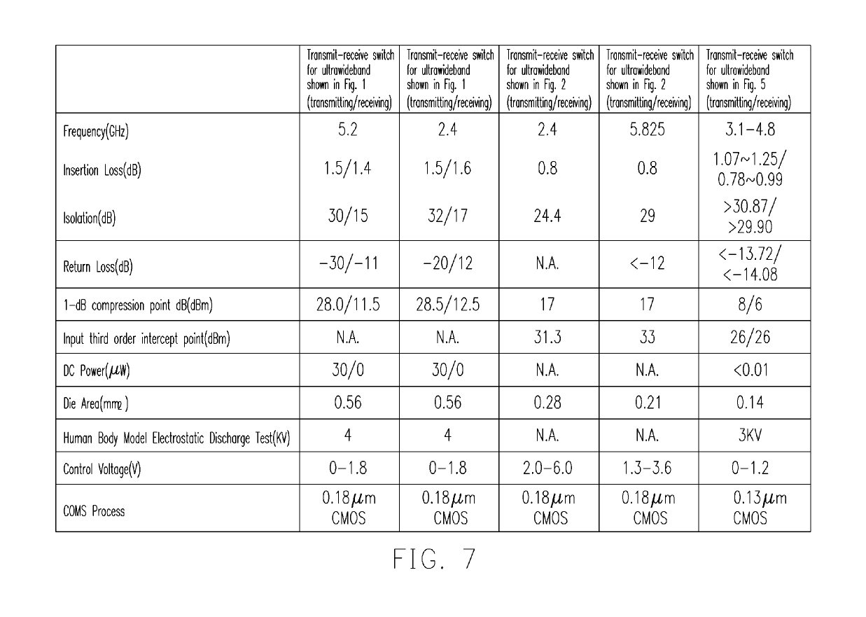

FIG. 7 is a comparison table of characteristics of the conventional transmit-receive switch for ultrawideband shown in FIGS. 1 and 2 and that of the transmit-receive switch for ultrawideband shown in FIG. 5 (the first transistor 501 and the second transistor 502 are NMOS transistors). Referring to FIG. 7, it shows various characteristics of the conventional transmit-receive switch for ultrawideband as shown in FIG. 1 when operating at a frequency band of 5.2 GHz and 2.4 GHz, characteristics of the conventional transmit-receive switch for ultrawideband as shown in FIG. 2 when operating at a frequency band of 2.4 GHz and 5.825 GHz, and characteristics of the transmit-receive switch for ultrawideband as shown in FIG. 5 according to the embodiment of the present invention when operating at a frequency band of 3.1-4.8 GHz, respectively.

As for each of the characteristics shown in FIG. 7, the lower the insertion loss is the better; the higher the isolation is the better; the return loss is a negative value, and the smaller the value is the better; the 1-dB compression point (IP1dB) and the input third order intercept point (IIP3) represent the linearity of the circuit, and the greater the value is the better. However, since the UWB is suitable for short distance wireless transmission, the value of the 1-dB compression point (IP1dB) of the transmit-receive switch for ultrawideband of the embodiment of FIG. 5 is not essentially too large. As for the direct current power, the transmit-receive switch for ultrawideband in the embodiment of FIG. 5 almost does not consume any power. As for the die region (area occupied by the die), the transmit-receive switch for ultrawideband in the embodiment of FIG. 5 only occupies a small area. Further, the control voltage of the transmit-receive switch for ultrawideband in the embodiment of FIG. 5 is only 0-1.2 V.

To sum up, the technique of the present invention lies in that: when the first transistor is turned on to allow the signal transmitting end to transmit an output signal, the control end of the second transistor is coupled to the ground voltage, such that the output signal that passes through the second transistor to the signal receiving end is conducted to the ground voltage by the second transistor through the control end of the second transistor by utilizing the parasitic capacitance of the second transistor. When the second transistor is turned on to allow the signal receiving end to receive an input signal, the control end of the first transistor is coupled to the ground voltage, such that the input signal that passes through the first transistor to the signal transmitting end is conducted to the ground voltage by the first transistor through the control end of the first transistor by utilizing the parasitic capacitance of the first transistor. Thus, the present invention can efficiently isolate the output signal and the input signal, thus avoiding the interference between the output signal and the input signal. In the present invention, one end of the inductor is coupled to the signal transmit-receive end, and the other end of the inductor is coupled to the ground voltage, such that the function of ESD protection is achieved in the present invention.

In addition, compared with the conventional transmit-receive switch for ultrawideband shown in FIG. 1, the present invention requires one inductor (two inductors are included in the conventional transmit-receive switch for ultrawideband shown in FIG. 1), such that the volume of the chip employing the transmit-receive switch for ultrawideband of the present invention is much smaller than that of the chip employing the conventional transmit-receive switch for ultrawideband shown in FIG. 1, and the bandwidth for the present invention is much wider. Compared with the conventional transmit-receive switch for ultrawideband shown in FIG. 2, the voltage level of the control signal of the present invention is not required to be high.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A transmit-receive switch for ultrawideband, comprising:
a first switch having a first end, a second end, and a control end, where the first end of the first switch is coupled to a signal transmitting end, the second end of the first switch is coupled to a signal transmit-receive end, and the control end of the first switch receives a first control signal, so as to decide whether or not to turn on the first switch according to the first controlling signal;
a second switch having a first end, a second end, and a control end, where the first end of the second switch is coupled to a signal receiving end, the second end of the second switch is coupled to the signal transmit-receive end, and the control end of the second switch receives a second control signal so as to decide whether or not to turn on the second switch according to the second controlling signal; and
an inductor with one end coupled to the signal transmit-receive end and the other end coupled to a first potential.

2. The transmit-receive switch for ultrawideband as claimed in claim 1, wherein the second control signal is an inverted phase of the first control signal.

3. The transmit-receive switch for ultrawideband as claimed in claim 2, further comprising an inverting device for inverting the first control signal to obtain the second control signal.

4. The transmit-receive switch for ultrawideband as claimed in claim 3, wherein the inverting device comprises an inverter with the input end coupled to the first control signal and with the output end outputting the second control signal.

5. The transmit-receive switch for ultrawideband as claimed in claim 4, wherein the inverting device further comprises:
a first resistor with one end coupled to the first control signal and the other end coupled to the input end of the inverter;
a second resistor with one end coupled to the input end of the inverter and the other end coupled to the control end of the first switch; and
a third resistor with one end coupled to the output end of the inverter and the other end coupled to the control end of the second switch.

6. The transmit-receive switch for ultrawideband as claimed in claim 1, wherein the first switch comprises an NMOS transistor, where the two source/drain ends of the NMOS transistor are respectively the first end and the second end of the first switch, and the gate end of the NMOS transistor is the control end of the first switch.

7. The transmit-receive switch for ultrawideband as claimed in claim 6, wherein the second switch comprises an NMOS transistor, the two source/drain ends of the NMOS transistor are respectively the first end and the second end of the second switch, and the gate end of the NMOS transistor is the control end of the second switch.

8. The transmit-receive switch for ultrawideband as claimed in claim 1, wherein the first switch comprises a PMOS transistor, where two source/drain ends of the PMOS transistor are respectively the first end and the second end of the first switch, and the gate end of the PMOS transistor is the control end of the first switch.

9. The transmit-receive switch for ultrawideband as claimed in claim 8, wherein the second switch comprises a PMOS transistor, two source/drain ends of the PMOS transistor are respectively the first end and the second end of the second switch, and the gate end of the PMOS transistor is the control end of the second switch.

10. The transmit-receive switch for ultrawideband as claimed in claim 1, wherein the signal transmit-receive end is coupled to an antenna.

11. The transmit-receive switch for ultrawideband as claimed in claim 1, wherein the first potential is a ground voltage.

12. A transmit-receive switch for ultrawideband, comprising:
a first transistor having a first end, a second end, and a control end, where the first end of the first transistor is coupled to a signal transmitting end and the second end of the first transistor is coupled to a signal transmit-receive end;
a second transistor having a first end, a second end, and a control end, where the first end of the second transistor is coupled to a signal receiving end and the second end of the second transistor is coupled to the signal transmit-receive end;
a control device coupled between the control end of the first transistor and the control end of the second transistor, where the control device receives a control signal and to turns on the first transistor or the second transistor according to the control signal;
wherein when the first transistor is turned on to allow the signal transmitting terminal transmit an output signal, the control end of the second transistor is coupled to the ground voltage by the control device, such that the output signal that passes through the second transistor to the signal receiving end is conducted to the ground voltage by the second transistor through the control end of the second transistor by the parasitic capacitance of the second transistor, and when the second transistor is turned on to allow the signal receiving end receive an input signal, the control end of the first transistor is coupled to the ground voltage by the control device, such that the input signal that passes through the first transistor to the signal transmitting end is conducted to the ground voltage by the first transistor through the control end of the first transistor by the parasitic capacitance of the first transistor; and
an inductor with one end coupled to the signal transmit-receive end and the other end coupled to the ground voltage.

13. The transmit-receive switch for ultrawideband as claimed in claim 12, the control device comprising:
an inverter with the input end receiving the control signal and the output end outputting the inverted signal of the control signal;
a first bypass device coupled between the input end of the inverter and the control end of the first transistor, for transmitting the control signal to the control end of the first transistor, where the first bypass device also receives the inverted signal of the control signal and decides whether or not to couple the control end of the first transistor to the ground voltage according to the inverted signal of the control signal; and
a second bypass device coupled between the output end of the inverter and the control end of the second transistor, for transmitting the inverted signal of the control signal to the control end of the second transistor, where the second bypass device also receives the control signal and decides whether or not to couple the control end of the second transistor to the ground voltage according to the control signal.

14. The transmit-receive switch for ultrawideband as claimed in claim 13, wherein the control device further comprises a first resistor with one end coupled to the control signal and the other end coupled to the input end of the inverter.

15. The transmit-receive switch for ultrawideband as claimed in claim 13, wherein the first bypass device comprises:
a second resistor coupled between the input end of the inverter and the control end of the first transistor;
a first switch having a first end, a second end, and a control end, where the first end and the second end of the first switch are respectively coupled to the two ends of the second resistor; the control end of the first switch receives the inverted signal of the control signal; and when the second transistor is turned on, the first switch is turned on; and
a first capacitor with one end coupled to the input end of the inverter and the other end coupled to the ground voltage.

16. The transmit-receive switch for ultrawideband as claimed in claim 13, wherein the second bypass device comprises:
a third resistor coupled between the output end of the inverter and the control end of the second transistor;
a second switch having a first end, a second end, and a control end, where the first end and the second end of the second switch are respectively coupled to the two ends of the third resistor; the control end of the second switch receives the control signal; and when the first transistor is turned on, the second switch is turned on; and
a second capacitor with one end coupled to the output end of the inverter and the other end coupled to the ground voltage.

17. The transmit-receive switch for ultrawideband as claimed in claim 12, wherein each of the first transistor and the second transistor comprises an NMOS transistor.

18. The transmit-receive switch for ultrawideband as claimed in claim 12, wherein each of the first transistor and the second transistor comprises a PMOS transistor.

19. The transmit-receive switch for ultrawideband as claimed in claim 15, wherein the first switch comprises an NMOS transistor.

20. The transmit-receive switch for ultrawideband as claimed in claim 16, wherein the second switch comprises an NMOS transistor.

21. A transmit-receive switch for ultrawideband, comprising:
a first MOS transistor with one source/drain end coupled to a signal transmitting end and the other source/drain end coupled to a signal transmit-receive end;
a second MOS transistor with one source/drain end coupled to a signal receiving end and the other source/drain end coupled to the signal transmit-receive end;
an inverting device with the input end coupled to the gate end of the first MOS transistor and the output end coupled to the gate end of the second MOS transistor, where the input end of the inverting device receives a control signal and the output end of the inverting device outputs the inverted signal of the control signal; and
an inductor, with one end coupled to the signal transmit-receive end and the other end coupled to a first potential.

22. The transmit-receive switch for ultrawideband as claimed in claim 21 wherein the inverting device comprises an inverter with the input end receiving the control signal and the output end outputting the inverted signal of the control signal.

23. The transmit-receive switch for ultrawideband as claimed in claim 22, wherein the inverting device further comprises:
a first resistor with one end coupled to the control signal and the other end coupled to the input end of the inverter;
a second resistor with one end coupled to the input end of the inverter and the other end coupled to the gate end of the first MOS transistor; and
a third resistor with one end coupled to the output end of the inverter and the other end coupled to the gate end of the second MOS transistor.

24. The transmit-receive switch for ultrawideband as claimed in claim 21, wherein each of the first MOS transistor and the second MOS transistor comprises an NMOS transistor.

25. The transmit-receive switch for ultrawideband as claimed in claim 21, wherein each of the first MOS transistor and the second MOS transistor comprises a PMOS transistor.

26. The transmit-receive switch for ultrawideband as claimed in claim 21, wherein the signal transmit-receive end is coupled to an antenna.

27. The transmit-receive switch for ultrawideband as claimed in claim 21, wherein the first potential is a ground voltage.

28. A method for isolating transmitting and receiving signal, applicable to a receiving/transmitting signal switching circuit including a first MOS transistor and a second MOS transistor, wherein one source/drain end of the first MOS transistor is coupled to a signal transmitting end and the other source/drain end of the first MOS transistor is coupled to a signal transmit-receive end; one source/drain end of the second MOS transistor is coupled to a signal receiving end and the other source/drain end of the second MOS transistor is coupled to the signal transmit-receive end, the method comprising:
when the first MOS transistor is turned on to allow the signal transmitting end transmit an output signal through the signal transmit-receive end, turning off the second MOS transistor and coupling the gate end of the second MOS transistor to the ground voltage; and
when the second MOS transistor is turned on to allow the signal receiving end receive an input signal through the signal transmit-receive end, turning off the first MOS transistor, and coupling the gate end of the first MOS transistor to the ground voltage, wherein the first MOS transistor and the second MOS transistor are not turned on simultaneously.

29. The method for isolating transmitting and receiving signal as claimed in claim 28, wherein each of the first MOS transistor and the second MOS transistor comprises an NMOS transistor.

30. The method for isolating transmitting and receiving signal as claimed in claim 28, wherein each of the first MOS transistor and the second MOS transistor comprises a PMOS transistor.

31. The method for isolating transmitting and receiving signal as claimed in claim 28, wherein the signal transmit-receive end is coupled to an antenna.
